(19) United States
(12) Patent Application Publication
(10) Pub. No.: US 2025/0392876 A1
(43) Pub. Date: Dec. 25, 2025

(54) HEARING AID SYSTEM AND A METHOD OF OPTIMIZING HEARING AID PARAMETERS

(71) Applicant: Widex A/S, Lynge (DK)

(72) Inventors: Jens Brehm Bagger NIELSEN, Ballerup (DK); Ellen Lundorff, Valby (DK); Kara Fiona Catriona Forsyth, Albertslund (DK); Strphane Le Borne, Copenhagen (DK); Blair Richard Johnsrude, Copenhagen (DK); Caspar Aleksander Bang Jespersen, Copenhagen (DK)

(73) Assignee: Widex A/S, Lynge (DK)

(21) Appl. No.: 19/311,832

(22) Filed: Aug. 27, 2025

Related U.S. Application Data
(63) Continuation of application No. PCT/EP2024/055926, filed on Mar. 6, 2024.
(60) Provisional application No. 63/488,602, filed on Mar. 6, 2023.

(51) Int. Cl. H04R 25/00; G06F 3/04817; G06F 3/04842

(52) U.S. Cl. CPC H04R 25/558; G06F 3/04817; G06F 3/04842; H04R 25/505; H04R 2225/55

(57) ABSTRACT

A method (100, 200) of optimizing a hearing aid system.

### CROSS-REFERENCE TO RELATED APPLICATIONS

This application is a Continuation of International Application No. PCT/EP2024/055926, filed on Mar. 6, 2024, which claims priority from U.S. Application No. 63/488,602, filed on Mar. 6, 2023, the entire contents of which are incorporated herein by reference.

### FIELD

The present invention relates to a hearing aid system. The invention also relates to a method of optimizing hearing aid parameters.

### BACKGROUND OF THE INVENTION

Within the context of the present disclosure a hearing aid can be understood as a small, battery-powered, microelectronic device designed to be worn behind or in the human ear by a hearing-impaired user. Prior to use, the hearing aid is adjusted by a hearing aid fitter according to a prescription. The prescription is based on a hearing test, resulting in a so-called audiogram, of the performance of the hearing-impaired user's unaided hearing. The prescription is developed to reach a setting where the hearing aid will alleviate a hearing loss by amplifying sound at frequencies in those parts of the audible frequency range where the user suffers a hearing deficit. A hearing aid comprises one or more microphones, a battery, a microelectronic circuit comprising a signal processor adapted to provide amplification in those parts of the audible frequency range where the user suffers a hearing deficit, and an acoustic output transducer. The signal processor is preferably a digital signal processor. The hearing aid is enclosed in a casing suitable for fitting behind or in a human ear.

Within the present context a hearing aid system may comprise a single hearing aid (a so called monaural hearing aid system) or comprise two hearing aids, one for each ear of the hearing aid user (a so called binaural hearing aid system). Furthermore the hearing aid system may comprise an external device, such as a smart phone having software applications adapted to interact with other devices of the hearing aid system. Thus within the present context the term “hearing aid system device” may denote a hearing aid or an external device.

Generally a hearing aid system according to the invention is understood as meaning any system which provides an output signal that can be perceived as an acoustic signal by a user or contributes to providing such an output signal and which has means which are used to compensate for an individual hearing loss of the user or contribute to compensating for the hearing loss of the user. These systems may comprise hearing aids which can be worn on the body or on the head, in particular on or in the ear, and can be fully or partially implanted. However, some devices whose main aim is not to compensate for a hearing loss may nevertheless be considered a hearing aid system, for example consumer electronic devices (ear buds, televisions, hi-fi systems, mobile phones, MP3 players etc.) provided they have measures for compensating for an individual hearing loss.

It is well known within the art of hearing aid systems that most users will benefit from a hearing aid programming (this process may also be denoted fitting) that takes the user's personal preferences into account. This type of fine tuning or optimization of the hearing aid system settings may be denoted personalization or using a more generic term it may be denoted a machine learning procedure. However, it is well known that the process of personalization is a very challenging one.

One problem with personalization is that it may be very difficult for a user to explain in words what types of signal processing and the associated resulting sounds that are preferred.

Personalization may generally be advantageous with respect to basically all the various types of signal processing that are carried out in a hearing aid system. Thus personalization may be relevant for e.g. noise reduction as well as for classification of the sound environment.

EP-B1-1946609 discloses a method for optimization of hearing aid parameters. The method is based on Bayesian incremental preference elicitation whereby at least one signal processing parameter is adjusted in response to a user adjustment. According to a more specific embodiment the user adjustment is simply an indication of user dissent.

EP-B1-1946609 is complicated in so far that it applies a parameterized approach in order to model the user's unknown internal response function (i.e. the user's preference), because it is very difficult to find a suitable parameterized model that suits the great variety of hearing aid system users unknown internal response functions.

Furthermore EP-B1-1946609 is complicated because the processing and memory requirements are very high, especially for hearing aid systems that generally have limited processing and memory resources.

It is therefore a feature of the present invention to provide an improved method of optimizing a hearing aid setting (i.e. a hearing aid parameter) with respect to at least ease of use, time spent by the user and the general user satisfaction.

It is another feature of the present invention to provide a hearing aid system with such improved means for optimizing a hearing aid system setting.

### SUMMARY OF THE INVENTION

The present invention is set forth in the appended set of claims.

This provides an improved hearing aid system with respect to optimization of hearing aid system settings.

### BRIEF DESCRIPTION OF THE DRAWINGS

By way of example, there is shown and described a preferred embodiment of this invention. As will be realized, the invention is capable of other embodiments, and its several details are capable of modification in various, obvious aspects all without departing from the invention. Accordingly, the drawings and descriptions will be regarded as illustrative in nature and not as restrictive. In the drawings:

FIG. 1 illustrates highly schematically a method of operating a hearing aid system according to a first embodiment of the invention, and

FIG. 2 illustrates highly schematically a method of operating a hearing aid system according to a second embodiment of the invention.

### DETAILED DESCRIPTION

In the present context the terms “hearing aid parameter” and “hearing aid setting” may be used interchangeably. The same is true for the terms “hearing aid system user”, “hearing aid system user” and simply “user”.

In most cases a plurality of settings (i.e. parameters) are optimized simultaneously but this need not be the case. Therefore, unless clearly emphasized that the opposite is the case, the terms “setting” and “settings” may be used interchangeably and the same is true for the terms “parameter” and “parameters”.

Similarly, the term “machine learning procedure screen” may be replaced with the more simple “screen” in order to improve readability.

According to an aspect of the invention it has been found that it provides a significant improvement for the user if the hearing aid system settings (i.e. the parameters) can be adapted to the user's current preferences (which in the following may be denoted optimized or personalized). This is even more so because the user's preferences may vary significantly up to several times during a day, as a function of e.g. the time of day (morning, afternoon or evening) or the user's mood or the type of activity the user is engaged in.

As a consequence of these varying preferences of many users it provides a significant improvement for the user if the personalization can be carried out without having to spend too much time optimizing the settings.

As an additional consequence of the varying preferences of many users it has been found that it provides a significant improvement for the user if the personalization generally can be carried out using only the hearing aid system with its limited processing resources, because this allows the personalization to be carried out anywhere and at any time.

Furthermore, it has been found that it is of significant importance that the personalization can be carried out without requiring the user to interact with the hearing aid system in a complex manner.

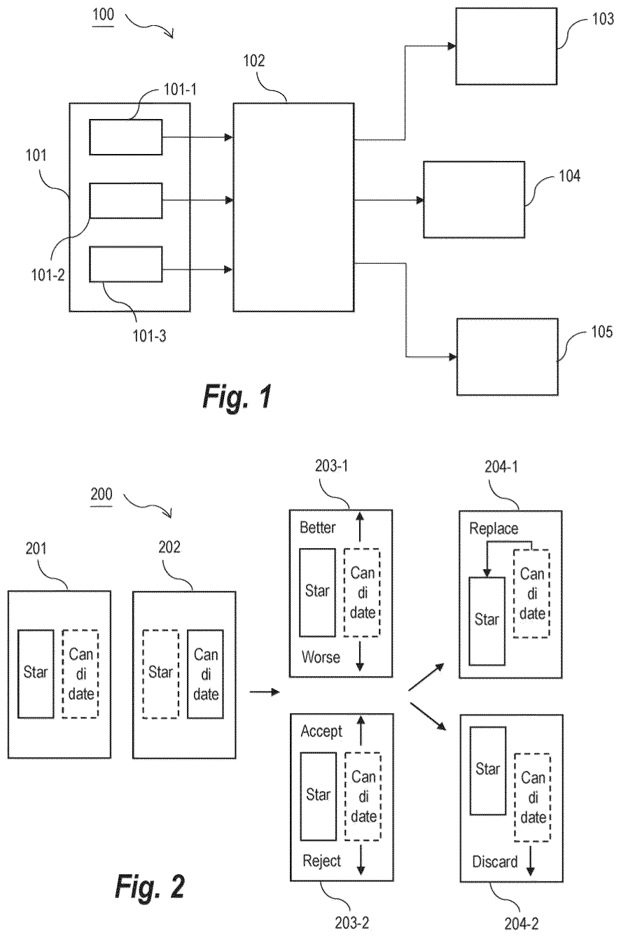

Reference is first made to FIG. 1 which illustrates highly schematically a method 100 of operating a hearing aid system according to a first embodiment of the invention. The hearing aid system comprises a portable computer device, including a processor and memory, and at least one hearing aid that are communicationally linked, wherein said portable computer device comprises an interactive display that is configured to provide a plurality of machine learning procedure screens adapted to optimize at least one hearing aid system setting of the hearing aid system.

In a first step one screen 101 is adapted to prompt a hearing aid system user to input an estimate of how long time the user prefers to spend optimizing settings of the hearing aid system (in the following this screen 101 may also be denoted the time budget screen). Thus according to an embodiment said one screen 101 comprises a plurality of selected time spans to choose between.

In FIG. 1 three different selectable options (101-1, 101-2 and 101-3) are given for the time the user wants to spend. According to an embodiment the first selectable option 101-1 is to use less than 10 seconds, the second selectable option 101-2 is to use less than 1 minute and the third selectable option 101-3 is to use around 5 minutes.

According to another embodiment the first selectable option 101-1 is to use as little time as possible, the second selectable option 101-2 is to use more than 10 seconds and less than 5 minutes and the third selectable option 101-3 is to allow the machine learning procedure to determine how much time to spend.

According to yet other embodiments more or less than 3 selectable options can be given.

According to an optional second step 102, the user is prompted to indicate his listening intent, which is used to impact the adaptation of at least one of a plurality of screens for a third 103, or a fourth 104 or a fifth step 105 of providing a plurality of screens adapted to assist said user optimizing the hearing aid system settings.

Additionally, or alternatively said optional second step 102 comprises determining (i.e. classifying) the sound environment and based hereon adapting said plurality of scenes.

According to a third 103, or a fourth 104 or a fifth step 105 a plurality of screens are adapted to assist said user optimizing the hearing aid system settings, wherein the screens, out of said plurality of screens, to be presented for the user depends on said estimate provided by the user.

According to an embodiment the hearing aid system is adapted to provide in a third step 103 and in response to a selection of the shortest possible time span or a time span of less than 10 seconds (101-1) an optimized hearing aid system setting based on at least one cluster analysis of preferred hearing aid system settings for similar hearing aid system users.

According to an embodiment the hearing aid system is adapted to provide in a fourth step 104 and in response to a selection of a time span of less than 1 minute or more than 10 seconds and less than 5 minutes (101-2), a plurality of machine learning procedure screens adapted to optimize said hearing aid system setting based on enabling the user to simply choose between different hearing aid system settings (104) based on at least one of listening intent as input by the hearing aid system user and a classification of the sound environment by the hearing aid system (102).

According to an embodiment the hearing aid system is adapted to provide in a fifth step 105, in response to a selection of a time span that is not specifically restricted or around 5 minutes (101-3) a plurality of machine learning procedure screens adapted to optimize said hearing aid system setting based on the hearing aid system user's assessment (i.e. evaluation) of different hearing aid system settings and optionally and additionally based on at least one of listening intent as input by the hearing aid system user and a classification of the sound environment by the hearing aid system (102).

According to an embodiment said hearing aid system setting optimization can be done using the methods disclosed in the U.S. Pat. No. 9,992,586 B2 by the same applicant., which is hereby incorporated by reference.

According to an embodiment at least one of said plurality of screens is adapted to control the time available to assess a given hearing aid setting based on the users input to said prompt provided by said one screen (101) adapted to prompt a hearing aid system user to input an estimate of how long time the user prefers to spend optimizing settings of the hearing aid system. Thus not only can the user's estimate of the available time be used to determine the type of optimization that is carried out. It can additionally be used to determine how much time a user has for making up his mind for at least one decision to be made as part of optimizing at least one hearing aid system setting.

In an embodiment the hearing aid system is configured to only present a machine learning procedure screen in response to a detection that said hearing aid system user is in a situation where it may make sense to spend time optimizing hearing aid system settings, wherein said detection is based on at least one of: detecting that the user is not walking, detecting that the user is not running, detecting that the user is not speaking and detecting that the user is not in a specific location.

In another embodiment the hearing aid system is configured to present a machine learning procedure screen prompting for an interaction in response to a specific trigger event defined by said hearing aid system user with respect to when to present said machine learning procedure screen, wherein said specific trigger event is based on at least one of: detection of a specific sound environment, a specific time based schedule and a specific location.

Thus the advantageous aspects of this first use case comprises: aligning with end-user up front about how much time he/she has for doing some sort of personalization (i.e. optimization of hearing aid system settings).

This is advantageous at least because:
with very little to no time available (e.g., when the hearing aid system user is actively engaged in a conversation, but cannot hear), the hearing aid system user does not generally have time to interact with the interactive display of the portable computer device (typically controlled by an “app”) and consequently it may make sense to just enable the hearing aid fitting system to select the setting to be active in the hearing aids based on at least one of context such as sound environment, info about the hearing aid system user which may be used for cluster analysis of similar user etc. The context may be selected by the end-user manually, but could also be automatically detected (e.g. based on a sound classification, or could be selected before the time-budget screen is provided.
with a little time available, e.g., up to a minute, the end-user might want to pick the best setting out of a few recommendations that can be based on at least one characteristic of the specific hearing aid system user such as age or hearing loss.
with considerable time available (e.g., when just being at home doing very little), the hearing aid system user could have the time to do some kind of training (e.g. using the methods disclosed in the U.S. Pat. No. 9,992,586 B2 by the same applicant, which is hereby incorporated by reference to update a hearing setting or to make one for later/the future.

According to more specific embodiment the training can be carried out with external sounds, such as sounds recorded by the user himself, which can significantly improve optimization of at least one hearing aid system setting for a specific—and typically recurring—sound environment.

Reference is now made to FIG. 2, which, like FIG. 1, illustrates highly schematically a method 200 of operating a hearing aid system according to a second embodiment of the invention. The hearing aid system comprises a portable computer device, including a processor and memore, and at least one hearing aid that are communicationally linked, wherein said portable computer device comprises an interactive display that is adapted to provide a plurality of machine learning procedure screens adapted to optimize settings of the hearing aid system.

In a first step one screen 201 is adapted to prompt and enable a hearing aid system user to test a “candidate” hearing aid setting instead of the “star” hearing aid setting, which represents the setting that is currently active in the at least one hearing aid and which is assumed to be the optimal setting.

Thus by pressing or holding for a while the icon that represents the “candidate” setting this setting is being activated in the hearing aid(s) for a fixed duration of time (such as 10 seconds or in the range between 5 and 15 seconds). This second step is illustrated by the second screen 202. In an embodiment the screen 202 is adapted to illustrate using a timer the progress of said fixed duration of time. Thus during said fixed duration of time the hearing aid system user listens to the sound environment with the candidate setting being active and assess his/her preference for this setting compared to the “star” setting that was (just) previously active. After the fixed duration the setting in the hearing aid(s) is switched back to the “star” setting.

The “candidate” setting may be selected (by the hearing aid system) in a number of different ways all of which will be well known for the skilled person. However, according to a more specific embodiment the “candidate” settings are determined based on the method disclosed in U.S. Pat. No. 9,992,586 B2 by the same applicant, which is hereby incorporated by reference.

In the third step illustrated by the (alternative) screens 203-1 and 203-2 the hearing aid system user is prompted to assess (as illustrated by screen 203-1) his (relative) preference for either the “star” or “candidate” setting or decide (as illustrated by screen 203-2) on his preference for either the “star” or “candidate” setting (i.e. decide whether to accept or reject the “candidate” setting in comparison to the “star” setting). Thus according to the two alternative embodiments given in the screens 203-1 and 203-2 the hearing aid system user indicates (his assessment of) his preference by swiping the “candidate” setting up or down. However, in an embodiment (not shown) the hearing aid system user can indicate his preference by swiping the “candidate” setting left or right. In another embodiment (not shown) the hearing aid system user can decide on his preference simply by activating the “candidate” setting icon.

In the fourth step illustrated by the screens 204-1 and 204-2 it is illustrated for the hearing aid system user whether the current “candidate” setting replaces the “star” setting and as such becomes the new “star” setting to be used onwards (as illustrated by screen 204-1) or whether the current “candidate” setting is simply discarded (as illustrated by screen 204-2).

In case the “candidate” setting is discarded the method 200 is started over again with a new “candidate” setting. According to an embodiment the new “candidate” setting is determined using the method disclosed in U.S. Pat. No. 9,992,586 B2.

One particular advantage of the method 200 is that the user knows exactly how the new “star” setting will sound, because the user has just listened to it (because the method will only stop if the hearing aid system user has preferred the most recent “candidate” setting). Generally, machine learning based optimization methods does not necessarily provide that advantage. Instead machine learning based optimizations are generally based on estimating the progress in the machine learning procedure with respect to fulfilling a convergence criterion (such as exceeding above or falling below a convergence threshold value), wherein said estimate of the progress e.g. can be based on a measure derived from an expected improvement. One example of such a measure is disclosed in U.S. Pat. No. 11,778,393 B2 which is hereby incorporated by reference.

From the above mentioned reference it is known that the formula for a bivariate Expected Improvement EI may be given by:

$$EI = {μ}_{1} Φ ( \frac{{μ}_{I}}{{σ}_{I}} ) + {σ}_{I} 𝒩 ( \frac{{μ}_{I}}{{σ}_{I}} \vert 0 , 1 ) ,$$

wherein

$$Φ ( \frac{{μ}_{I}}{{σ}_{I}} )$$

is the standard cumulative distribution function of the Gaussian distribution;
wherein \hat{x} is the current best parameter value setting;
wherein the set [symbol] * of all n* possible parameter value settings is expressed as:

$${𝒳}^{*} = \{ {x}_{r}^{*} ∈ {ℝ}^{d} : r = 1 , … , {n}^{*} \}$$

and wherein \hat{x}* is the parameter value setting that maximizes the bivariate Expected Improvement, and wherein

$${μ}_{I} = {μ}^{*} - {μ}_{max} = ( {k}_{*} ( {x}^{*} ) - {k}_{*} ( \hat{x} ) ) \cdot {( {M}^{T} M K + {σ}^{2} {I}_{n \times n} )}^{- 1} {M}^{T} z ,$$

$$and$$

$${σ}_{I}^{2} = {σ}_{*}^{2} + {σ}_{max}^{2} - 2 {Cov}_{max , *} = k ( {x}^{*} , {x}^{*} ) + k ( \hat{x} , \hat{x} ) - k ( {x}^{*} , \hat{x} ) - {{k}_{*} ( {x}^{*} )}^{T} {( {M}^{T} M K + {σ}^{2} {I}_{n \times n} )}^{- 1} {M}^{T} M {k}_{*} ( {x}^{*} ) - {{k}_{*} ( \hat{x} )}^{T} {( {M}^{T} M K + {σ}^{2} {I}_{n \times n} )}^{- 1} {M}^{T} M {k}_{*} ( \hat{x} ) - {k}_{*} {( {x}^{*} )}^{T} {( {M}^{T} M K + {σ}^{2} {I}_{n \times n} )}^{- 1} {M}^{T} M {k}_{*} ( \hat{x} ) ,$$

wherein I_{m×m} is an m×m identity matrix, z=[z₁, . . . , zₘ]^{T}=[g(y₁), . . . , g(yₘ)]^{T}, the matrix M is a m×n matrix, comprising only zeros except for the elements

$${[ M ]}_{k , {u}_{k}} = 1 {and [ M ]}_{k , {v}_{k}} = - 1 .$$

Thus [symbol] (z|Mf, σ²I_{m×m}) represents a multivariate Gaussian distribution over the set of user responses z with mean vector Mf and covariance matrix σ²I_{m×m},
wherein the warped observations z are given by:

$$z = f ( {x}_{u} ) - f ( {x}_{v} ) + ϵ$$

wherein c is Gaussian noise (ϵ˜N(0,σ²)) that is independent and identically distributed and represents the uncertainty of the user when carrying out the graduated responses and:

$${k}_{*} ( x ) = [ k ( x , {x}_{i} ) , … , k ( x , {x}_{n} ) ]$$

The normalized expected improvement can be given as:

$$= \frac{\overline{EI}}{{EI}_{n o r m}} = \frac{\sqrt{π} {\sum }_{i = 1}^{N} {EI}_{i}}{{σ}_{f} N}$$

wherein N represents the number of a plurality of parameter settings and wherein of is a measure of the uncertainty of the user when comparing different parameter settings.

In an embodiment the method 200 (and its variations) comprises the additional steps of determining in the background a measure derived from the expected improvement of the “star” setting with respect to the hearing aid system users preference function (which may also be denoted the internal response function) each time the method 200 is started over (i.e. for each new iteration), whereby the relative progress of said measure from one iteration to the next can be determined and in response hereto the hearing aid system user experience can be improved (using the machine learning procedure screens of the method 200) by at least one of the following types of information (in addition to the information already provided in the screens of the method 200) being provided:
information suggesting that the hearing aid system user should assess the difference between the “star” and “candidate” setting (screen 203-1) more aggressively in case the determined relative progress of said measure (for at least one iteration) is below a certain threshold.
informing the hearing aid system user of at least one characteristic of at least one stage of the optimization process based on the absolute value of said measure.

According to an embodiment the different stages are characterized by at least one of:
a first stage (for (the absolute value) of said measure being less than 20% or in the range between 15% and 25%) representing that the optimization is just initiated.
a second stage (for said measure being in the range between 20% and 40%) representing that most likely more optimizations are required to obtain a good result and consequently the hearing aid system user is encouraged to proceed with assessing the relative preferability of different hearing aid system setting. In a variation at least one of said upper and lower levels of the range may be increased or decreased with 5%.
a third stage (for said measure being in the range between 40% and 60%) representing that maybe the sound quality is sufficiently good, but it is also likely that it makes sense to proceed with the optimization. In a variation at least one of said upper and lower levels of the range may be increased or decreased with 5%.
a fourth stage (for said measure being in the range between 60% and 80%) representing that most likely the sound quality is sufficiently good, however if that is not deemed to be the case it can make sense to proceed despite that only minor improvements are to be expected at this point. In a variation at least one of said upper and lower levels of the range may be increased or decreased with 5%.
a fifth stage (for said measure being in the range between 80% and 95%) representing that the most likely the sound quality is as good as it gets and probably it will make good sense to stop optimizing at this point if the perceived sound quality is sufficiently good. In a variation at least one of said upper and lower levels of the range may be increased or decreased with 5%.

In another embodiment the hearing aid system comprising a portable computer device and at least one hearing aid that are communicationally linked, wherein said portable computer device comprises an interactive display that is configured to provide a plurality of machine learning procedure screens adapted to optimize at least one hearing aid system setting is furthermore adapted to assist a hearing aid system user optimizing at least one hearing aid system setting based on
an initial screen of said plurality of machine learning procedure screens is adapted to prompt the hearing aid system user to select at least one present activity and adapted to prompt the hearing aid system user to select at least one intention in the present situation or that the activity and intention is inferred automatically by the hearing aid system based at least partly of a sound environment classification; and based on
a first subsequent screen subsequent to said initial screen is adapted to comprise a plurality of first icons each representing a specific hearing aid system setting, and wherein each of said plurality of specific hearing aid system settings are selected based on the selected or inferred information of the present activity and intention of the hearing aid system user;
wherein each of said plurality of first icons can be activated using the interactive display and in response hereto change the hearing aid system setting for a predetermined amount of time,
wherein each of said plurality of first icons is furthermore adapted to enable the hearing aid system user to assess the specific hearing aid system setting represented by said icon;
wherein a second subsequent screen subsequent to said first subsequent screen is adapted to provide a second icon enabling the user to select an identified preferred hearing aid system setting if the hearing aid system has been able to identify such a preferred hearing aid system setting based on the user assessments provided to said first subsequent screen and if the hearing aid system has not been able to identify such a preferred hearing aid system setting, then said second icon will not be provided,
   and wherein said second subsequent screen additionally is adapted to provide a third icon enabling the user in response to activating the third icon to proceed to a third subsequent screen, subsequent to said second subsequent screen;
wherein said third subsequent screen is adapted for further hearing aid system setting optimization based on the information and assessments already provided by the hearing aid system user.

According to yet another embodiment the hearing aid system comprising a portable computer device and at least one hearing aid that are communicationally linked, wherein said portable computer device comprises an interactive display that is configured to provide a plurality of machine learning procedure screens adapted to optimize at least one hearing aid system setting is furthermore adapted to assist a hearing aid system user optimizing the hearing aid system settings based on a screen of said plurality of screens being adapted to enable a user to optionally select to optimize hearing aid system settings based on pre-recorded sound pieces representing common sound environments or sound pieces recorded by the hearing aid system user,
wherein at least one subsequent screen is adapted to offer a hearing aid system setting optimization procedure that is based on said pre-recorded or user recorded sound pieces, and
wherein said optimized hearing aid system setting obtained through said procedure is subsequently used by the hearing aid system in normal mode where the sound environment provides the sound input to the hearing aid system.

As can be understood from the foregoing disclosure, in non-limiting embodiments, the invention involves a hearing aid system including a portable computer device communicationally linked to at least one hearing aid. The system includes an interactive display and a machine learning optimization module configured to present a plurality of machine learning procedure screens. These screens facilitate the optimization of hearing aid system settings based on user input, contextual data, and adaptive algorithms, and can be performed in real-time. The system can allow for fine tuning or optimization of the hearing aid system settings (personalization or a machine learning procedure) to be carried out anywhere and anytime.

The portable computer device can include, among others, one or more of the following components:
an interactive display for presenting machine learning procedure screens.
a machine learning optimization module for executing optimization procedures.
a user interface engine for managing screen presentation and user interaction.
a decision logic module for selecting screens based on user input.
a context detection module for determining suitable optimization conditions.
a trigger event module for initiating optimization based on environmental or temporal triggers.
an improvement estimation module for calculating expected improvement metrics.

The system can present a sequence of machine learning procedure screens to the user. An initial screen can prompt the user to select a preferred time span for optimization.

Based on this input, the decision logic module selects subsequent screens that guide the user through optimization procedures. These procedures may include, among others:
cluster-based optimization using historical data.
multi-step assessments of candidate settings.
selection between pre-classified settings based on listening intent and sound environment.
evaluation of settings using pre-recorded or user-recorded sound samples.
adaptive encouragement based on expected improvement metrics.

Icons representing hearing aid system settings can be used throughout the interface. Users can activate icons to apply candidate settings temporarily and assess their preferences. The system can update icon representations based on user assessments and may introduce new candidate settings for further evaluation.

The described system achieves several technical effects, including:
improved user interaction efficiency through context-aware screen presentation.
enhanced system responsiveness via real-time adaptation to user input and environmental conditions.
personalized optimization of hearing aid settings using machine learning and user-specific preference functions.
reduction of user burden through automated decision logic and adaptive encouragement mechanisms.
integration of sound environment classification and sensor data to inform optimization procedures.

The foregoing description of certain embodiments has been presented for purposes of illustration and description. It is not intended to be exhaustive or to limit the invention to the precise forms disclosed. Modifications and variations will be apparent to those of ordinary skill in the art without departing from the scope and spirit of the invention. The embodiments were chosen and described in order to best explain the principles of the invention and practical application, and to enable others skilled in the art to understand the invention for various embodiments with modifications suited to particular uses. The scope of the invention is defined by the appended claims and their equivalents.

1-15. (canceled)

16. A hearing aid system comprising:
a portable computer device communicationally linked to at least one hearing aid;
wherein the portable computer device comprises:
an interactive display;
a machine learning optimization module configured to execute a plurality of machine learning procedures;
a user interface engine configured to present, via the interactive display, a plurality of machine learning procedure screens, each screen being configured to facilitate optimization of at least one hearing aid system setting based on user input and contextual data; and
wherein the machine learning optimization module is configured to adaptively modify hearing aid system settings in response to user interaction with said screens and real-time system feedback.

17. The hearing aid system of claim 16, wherein the machine learning procedure screens comprise:
a time estimation screen configured to prompt the user to select a preferred time span for optimization, and
a plurality of subsequent screens selected based on the user's time input, and
wherein the user interface engine dynamically selects and presents said subsequent screens based on a decision logic that prioritizes optimization strategies according to the selected time span.

18. The hearing aid system of claim 17, wherein the time estimation screen comprises selectable time spans comprising:
less than 10 seconds,
approximately 1 minute,
approximately 5 minutes, and
wherein the system stores the selected time span and uses it to configure the optimization flow.

19. The hearing aid system of claim 17, wherein:
in response to selection of time span, the system presents a screen configured to apply a cluster-based optimization derived from historical data of similar users;
in response to selection of time span, the system presents a screen configured to guide the user through a multi-step assessment of hearing aid settings;
in response to selection of time span, the system presents a screen configured to allow the user to select between pre-classified hearing aid settings based on listening intent and sound environment classification.

20. The hearing aid system of claim 17, wherein the system controls the duration of each optimization screen presentation based on the selected time span, using a timing controller that adjusts evaluation intervals for each hearing aid setting.

21. The hearing aid system of claim 16, further comprising a context detection module configured to suppress presentation of machine learning procedure screens unless the user is in a context suitable for optimization, wherein said context is determined based on sensor input indicating that the user is not walking, not running, not speaking, or is located in a predefined location.

22. The hearing aid system of claim 16, further comprising a trigger event module configured to present a machine learning procedure screen in response to a user-defined trigger event, wherein the trigger event is based on at least one of:
detection of a specific sound environment via acoustic sensors,
a time-based schedule managed by a system clock,
detection of a specific location via a positioning module; and
wherein the system achieves a technical effect of improving optimization timing and user engagement through context-aware interaction.

23. The hearing aid system of claim 16, wherein the machine learning procedure screens include a first screen comprising:
a first icon representing a currently active hearing aid system setting,
a second icon representing a candidate hearing aid system setting,
the second icon is configured to be activated via the interactive display, triggering the system to temporarily apply the candidate setting for a predetermined duration,
a first subsequent screen is configured to enable the user to assess the candidate setting relative to the current setting, and
a second subsequent screen is configured to update the icon representation, replacing the first icon with the second icon if the user assessment indicates a preference for the candidate setting, thereby updating the active hearing aid system setting.

24. The hearing aid system of claim 23, wherein a third subsequent screen is configured to present:
a new second icon representing a new candidate hearing aid system setting, and
a confirmation icon enabling the user to finalize the optimization and retain the currently active hearing aid system setting.

25. The hearing aid system of claim 16, further comprising:
an improvement estimation module configured to calculate a normalized expected improvement of a candidate hearing aid system setting relative to a user-specific internal preference function;
wherein the calculated improvement is used to guide the user through a sequence of machine learning procedure screens aimed at optimizing the hearing aid system setting.

26. The hearing aid system of claim 25, wherein the improvement estimation module is configured to prompt the user to perform more frequent or detailed assessments of candidate settings when the normalized expected improvement falls below a predefined threshold.

27. The hearing aid system of claim 25, further configured to determine at least one characteristic of the optimization process based on the absolute value of the normalized expected improvement.

28. The hearing aid system of claim 27, wherein the at least one characteristic of the optimization process is screen duration, number of candidate settings, or assessment granularity.

29. The hearing aid system of claim 16, wherein the machine learning procedure screens comprises:
an initial screen configured to prompt the user to select a current activity and intention, based on user input or the current activity and intention is inferred automatically by the hearing aid system based at least partly of a sound environment classification;
a first subsequent screen presenting a plurality of first icons, each of the plurality of first icons representing a specific hearing aid system setting selected based on the selected or inferred current activity and intention;
a second subsequent screen presenting a second icon for selecting a preferred setting if identified from prior assessments and a third icon for proceeding to a third subsequent screen for further optimization based on prior input.

30. The hearing aid system of claim 16, wherein said plurality of machine learning procedure screens comprises:
a screen configured to allow the user to initiate optimization based on pre-recorded sound samples representing common environments or user-recorded samples; and
a subsequent screen configured to apply optimization procedures using said sound samples; and
wherein the resulting optimized setting is stored and applied during normal operation when similar sound environments are detected.

31. A method of optimizing a hearing aid system, comprising:
presenting a sequence of machine learning procedure screens via an interactive display of a portable computer device communicationally linked to at least one hearing aid;
receiving user input and contextual data;
adaptively modifying hearing aid system settings based on user assessments, environmental classification, and calculated expected improvement metrics.
